(19) United States
(12) Patent Application Publication
(10) Pub. No.: US 2006/0138766 A1
(43) Pub. Date: Jun. 29, 2006

(54) Pre-formed printable blank label system for a slim-line CD jewel case and packaging method

(76) Inventor: Peter Johann Kielland, Ottawa (CA)

Correspondence Address: J. GORDON THOMSON, P.O. BOX 8865, VICTORIA, BC, V8V 3Z1, CA

(21) Appl. No.: 11/023,123

(22) Filed: Dec. 28, 2004

(51) Int. Cl. B42D 15/00

(52) U.S. Cl. 283/81

(57) ABSTRACT

A label system for a slim-line CD jewel case comprises a label having first, second and third faces. The first and third faces are adapted to receive first and second sets of printed matter. The third face fits along the narrow spine of the CD jewel case. The label is carried on a carrier sheet through the computer printer. In a preferred embodiment the label is a dodecagonal sheet having adjacent first, second, third, fourth and fifth faces. The first and third faces are adapted to receive a first and second set of printed matter from a computer printer. The fourth and fifth faces separate the third face from the mechanical margins of the printer so a carrier sheet is not required. The invention includes a virtual label template to be displayed on a computer screen so that printed matter can be placed on the first and third faces of the labels.

### BACKGROUND

1. Field of the Invention

This invention relates to printable labels for use in a computer printer and more particularly to a pre-formed printable blank label system for a slim-line CD jewel case.

2. Background of the Invention

The proliferation of digital data applications together with the advent of personal computers equipped with recording devices able to read and write to CDs has resulted in vast numbers of blank CDs being recorded for personal use. Each recorded CD is typically stored in a standard jewel case having a thickness of 10 mm. The CD is only 1.2 mm thick so most of the volume within a typical 10 mm thick jewel case remains unused. One of the main reasons for making CD cases thicker than required is to present a spine with a wide enough surface to permit labeling by hand or by a computer printer. Spine labeling is advantageous because it permits many CD cases to be stacked onto bookshelves or the like with each CD title plainly visible on the spine. Spine labeling thereby enables users to visually search for and identify a desired CD case without having to physically disturb any of them. The spine label's presence and legibility are therefore of prime importance and relevance to the present invention. However, with the advent of the 5 mm thick “slim-line” CD jewel case the spine is too narrow for conventional labels and even more difficult to hand-label or label using a computer printer. This inability to clearly label their very narrow spines effectively restricts the use of slim-line cases to slant storage bins that require the user to flip through the cases to view their large face labels.

One example of a printable label used with a CD jewel case is shown in U.S. Pat. No. 6,155,026 “Perforated Stock for Labeling CD-ROM Jewel Case” issued to Tracy on Dec. 5, 2000. Generally, prior art labeling systems suffer from several drawbacks such as: having to tear or cut away and then discard those portions of the printed sheet that fall outside the label boundaries; having to discard the label that was supplied with the jewel case; and, not being able to easily package replacement labels with the CD.

Therefore, there continues to be a need for a more convenient pre-formed printable label for use with slim-line CD jewel cases that can also be easily packaged together with its CD case during distribution and sale.

### OBJECTS OF THE INVENTION

It is an object of the present invention to overcome the deficiencies noted with prior art for CD slim-line jewel case labels.

It is another object of the invention to provide a user-printable label insert for CD slim-line cases that does not waste paper.

It is yet another object of the present invention to provide a user-printable label insert that provides cleanly cut and straight label edges and folds.

It is another object of the present invention to provide a user-printable label insert for slim-line CD jewel cases that displays maximally legible label text through the case's narrow, transparent spine.

It is yet another object of the present invention to provide a user-printable label insert that may be efficiently packaged together with each CD case during retail display.

### SUMMARY OF THE INVENTION

To overcome the deficiencies of the prior art and meet the objectives stated herein, my invention comprises a pre-formed paper insert for labeling the user-recorded contents of a slim-line jewel case that is adapted for displaying text though the case's narrow transparent spine by means of a spine-sized label panel folded at right angles to the label's larger face panel. Small cutouts through both label panels provide clearance around the case cover's hinges, thereby permitting the face panel to lie against the inside of the cover with its spine panel flush inside the cover's spine edge.

In another embodiment of the label, a foldout portion adjacent to the its spine portion serves as a spacer for distancing the spine portion at a known distance from the printer's mechanical margin as well as providing structural integrity to the exposed portion of the inserted label. Prior to use, this spacer portion is folded flat against the label's main body, thereby permitting the label to lie flat against the CD case while packaged for transport and during retail sales display.

To enable any standard office printer and desktop computer to print text that is nearly flush to the edge of the label's narrow spine panel, a special “carrier sheet” is provided that temporarily holds the flattened label against the page so that the label is well away from the printer's unprintable margins. In one embodiment of the carrier page, two diagonal slits are pierced through the carrier page such that they may engage the two free corners of the label's face panel, thereby holding the label at a predetermined location on the page and enabling a word processing template to print text right up to the edge of the spine panel.

In another embodiment, a patch of low-tack “repositionable” adhesive on the carrier page is used to temporarily secure the blank label at the target location on the carrier page during printing.

In another embodiment, the labels are inserted directly into the printer thereby imposing unprintable margins along some but not all of its edges. In this embodiment, the narrow spine portion of the label is oriented and positioned towards the center of the printer, thereby permitting the spatially coordinated software of my invention to print full-height text across the entire width of the spine panel. Text on the label's much larger main panel is also composed using the coordinated software template such that the mechanical margins of the printer do not impinge on the printed area.

Labeling of the CD disk contained within its jewel case may also be supported through the provision of software that prints the same data shown on the case's label insert onto adhesive labels that are subsequently affixed to the disk contained within.

Software and labeling means may also be provided for printing “liner note” information onto pages that fold twice into the correct dimension for engaging under the retention tabs inside standard CD case covers.

A modified slim-line CD jewel case configuration may also be provided that is optimized for receiving the printed label insert with minimal dimpling of the label. The modified jewel case utilizes an eccentric CD placement in the lower case half combined with a supplementary paper guide formed near its hinge end. The effect of these modifications is to apply a more even gripping pressure onto the label insert, thereby reducing label dimpling as well as minimizing any tendency for the case halves to separate near their common hinge.

### BRIEF DESCRIPTION OF THE DRAWINGS

FIG. 1 is one view of a typical slim-line CD jewel case.

FIG. 2 is the same view as shown in FIG. 1.

FIG. 3 illustrates one embodiment of the label of my invention.

FIG. 3A illustrates printed matter on one embodiment of the label of my invention.

FIG. 4 illustrates one embodiment of a carrier sheet for one embodiment of my invention.

FIG. 5 illustrates another embodiment of a carrier sheet of one embodiment of my invention.

FIG. 6 illustrates yet another embodiment of a carrier sheet of one embodiment of my invention and an adhesive strip.

FIG. 7 illustrates an alternate way to temporarily fix the label to the carrier sheet.

FIG. 8 illustrates the liner notes of one embodiment of my invention.

FIG. 9 illustrates the software template of one embodiment of my invention.

FIG. 10 illustrates a CD labeled using one embodiment of my invention.

FIG. 11 illustrates a software template of another embodiment of my invention.

FIG. 12 illustrates a preferred embodiment of the label of my invention.

FIG. 13 illustrates printed matter on a preferred embodiment of the label of my invention.

FIG. 14 illustrates a preferred embodiment of the label of my invention within a slim-line CD jewel case.

FIG. 15 illustrates the accompanying software template for the preferred embodiment of the label of my invention.

FIG. 16 illustrates dimensions of a preferred embodiment of my invention.

FIG. 17 illustrates dimensions of one embodiment of my invention.

FIG. 18 illustrates another embodiment of the label of my invention.

FIG. 19 illustrates an improved slim-line CD jewel case of my invention.

FIG. 20 illustrates one packaging configuration of my invention.

FIG. 21 illustrates a second packaging configuration of a preferred embodiment my invention.

FIG. 22 illustrates a complete CD slim-line jewel case with a preferred embodiment label folded for packaging.

### DETAILED DESCRIPTION

Typical Slim Line CD Jewel Case

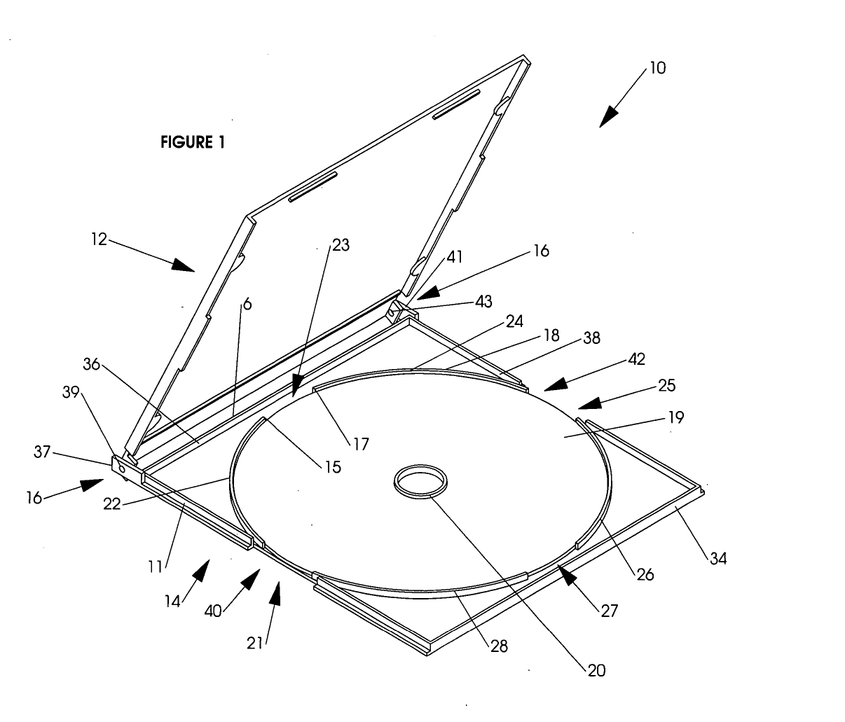

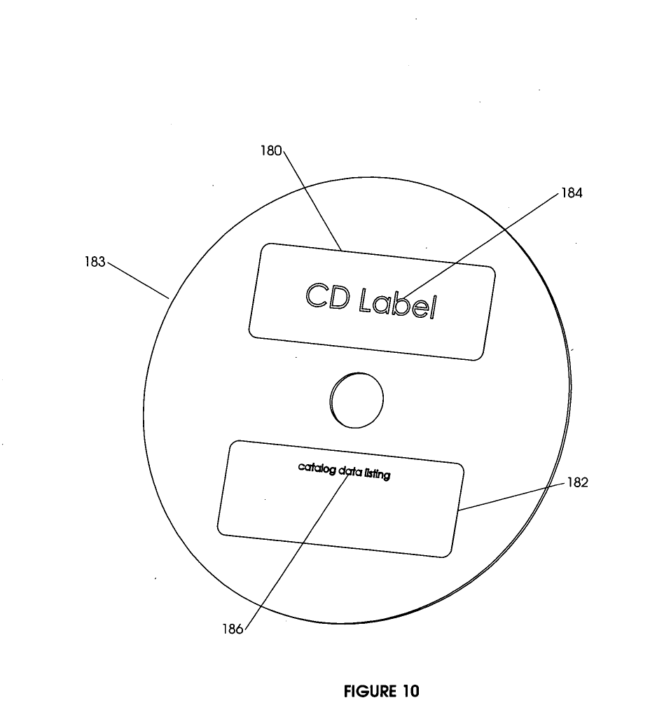

Referring to FIG. 1, there is illustrated a typical slim-line CD jewel case (10) used for protecting and storing a digital CD an example of which is illustrated in FIG. 10. This standardized case is comprised of transparent cover (12) attached in a clamshell manner to base (14) via hinges (16). A CD is secured into disk tray (19) by means of circular outer flange (18) and inner flange (20). The circular outer flange (18) is typically interrupted at (21), (23), (25) and (27) into four sections (22), (24), (26) and (28) as illustrated. The inner flange (20) grips onto the inside rim of the CD aperture. The jewel case (10) base (14) has a front wall (34), a rear wall (36), a left side wall (11) and a right side wall (38). The left side wall (11) has a gap (40) and the right side wall has a gap (42) adjacent to interruptions (21) and (25) in the circular outer flange (18). The left side wall (11) includes a rearward first projecting member (37) having a first inwardly projecting pin (39). The right side wall (38) has a rearward second projecting member (41) having a second inwardly projecting pin (43).

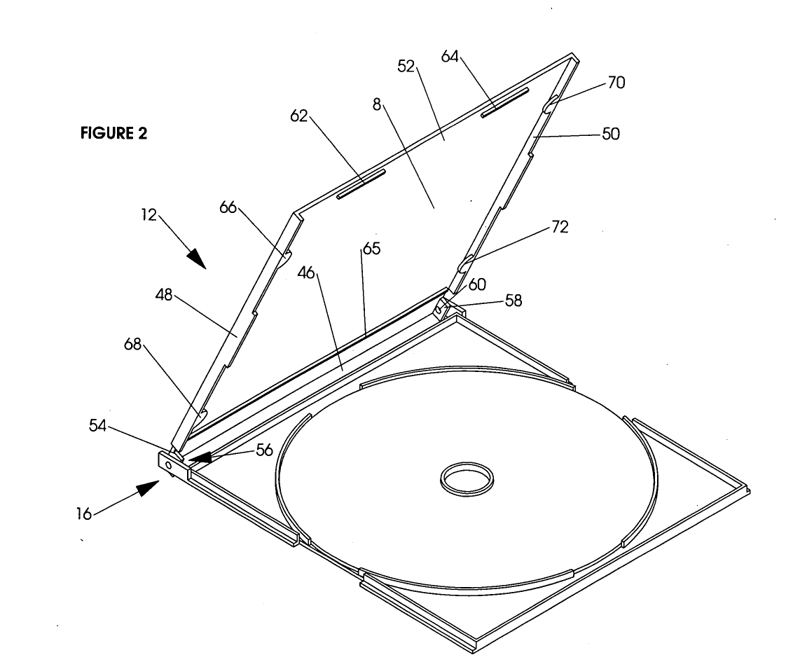

Referring to FIG. 2, which is identical to FIG. 1, the jewel case further includes rectangular hinged cover (12) having a rearward skirt (46) forming the spine of the case, a left side skirt (48), a right side skirt (50) and an open forward end (52). The rear of the left side skirt includes a first projecting member (54) having a first aperture (56). The rear of the right side skirt includes a second projecting member (58) having a second aperture (60). The top cover includes ridges (62) and (64) which together with projecting left side tabs (66) and (68) and right side projecting tabs (70) and (72) retain an inserted label within the transparent cover and prevent it from moving within the cover as the case is opened and closed. The tabs also hold the label against the inside surface (8) of the cover. Ridges (62) and (64) may be replaced by a continuous ridge (not shown) proximate to the open front end of the cover. There is also ridge (65) disposed near the rear edge of the cover.

The hinges (16) comprises the base member rearward left projection (37) having the first inwardly protruding pin (39), the base member rearward right projection (41) having the second inwardly protruding pin (43), the cover rearward left projection (54) having a first aperture (56) and the cover rearward right projection (58) having a second aperture (60) such that the first pin meshes with the first aperture and the second pin meshes with the second aperture so that the cover and base are joined in a clam shell-like pivoting relationship at their respective rearward ends.

### A First Embodiment

The Pre-Formed Blank Label

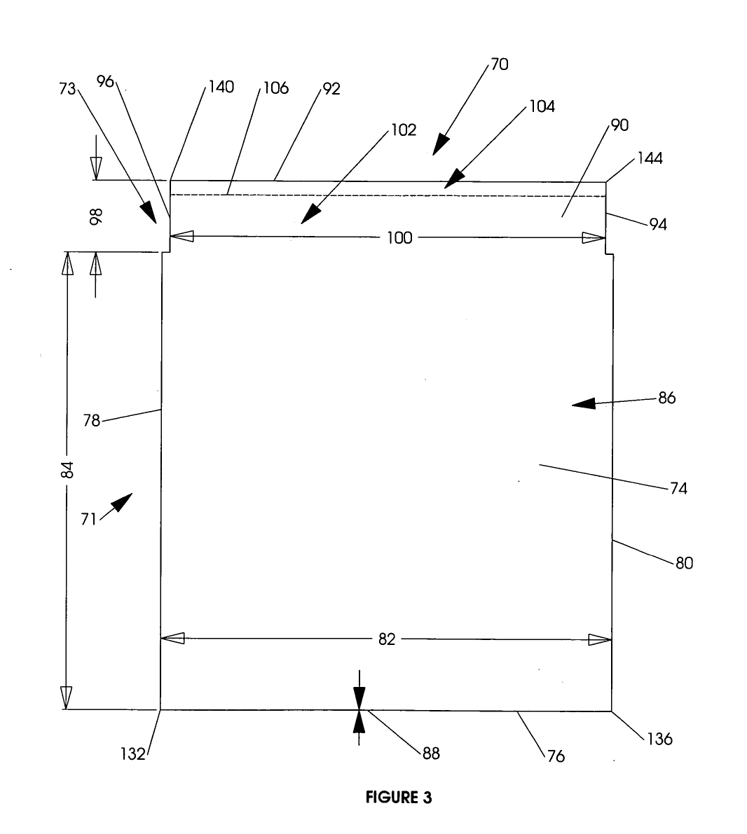

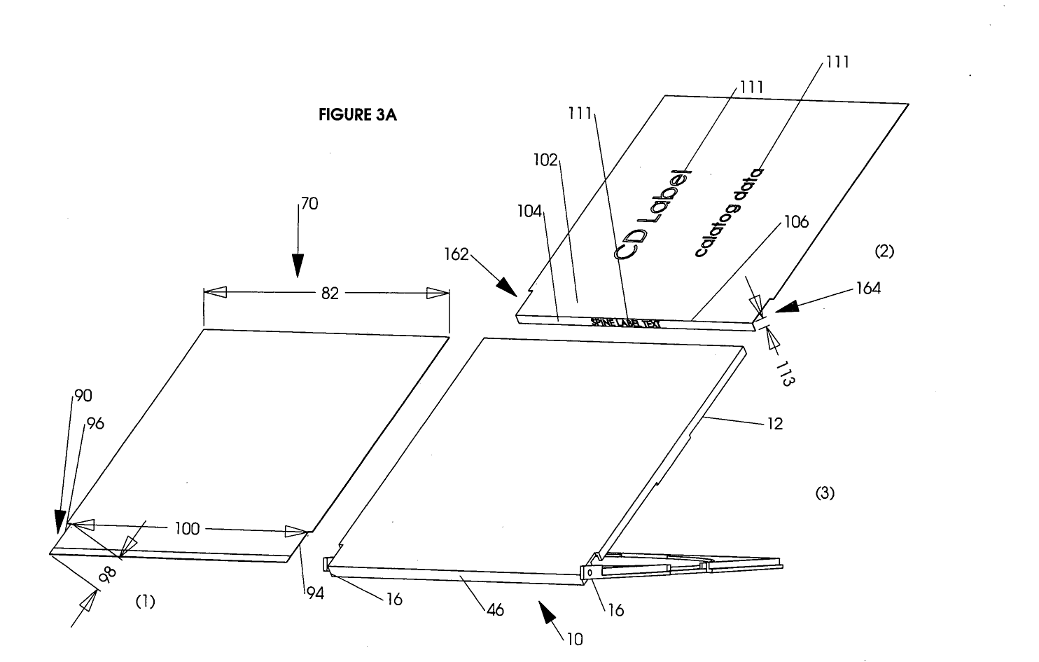

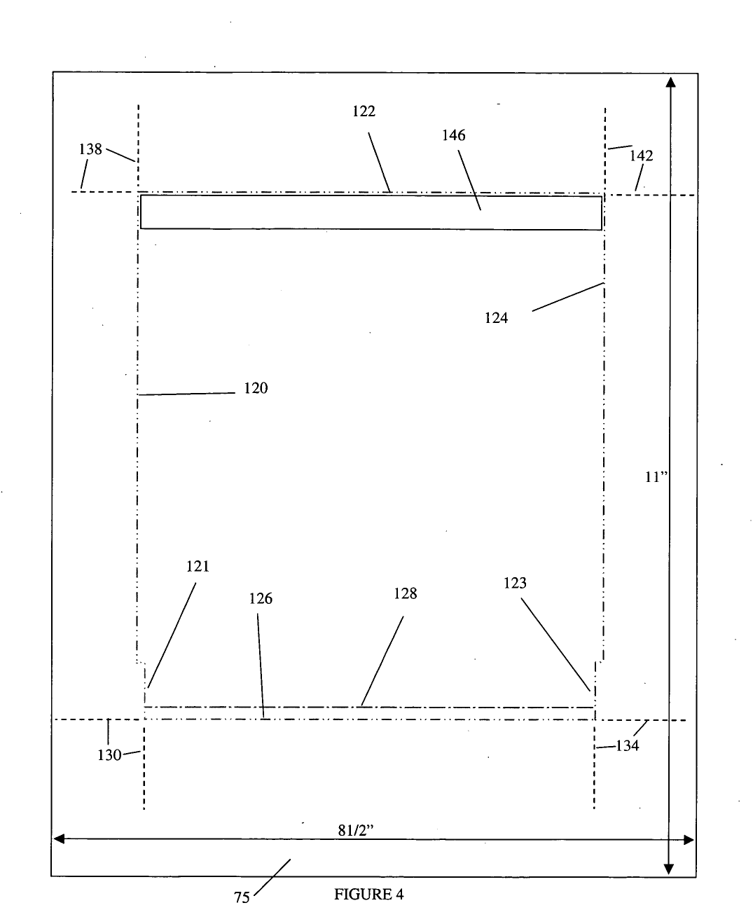

Refer now to FIG. 3, FIG. 3A and FIG. 4. Having described a typical slim-line CD jewel case with reference to FIG. 1 and FIG. 2, I will now describe a first embodiment of my invention. This first embodiment of my invention is a pre-formed printable blank label system for a slim-line CD jewel case as described in FIG. 1 and FIG. 2. The pre-formed printable blank label system comprises a label comprising a preformed octagonal sheet (70) having contiguous and adjacent first (71) and second (73) portions and a carrier sheet (75) illustrated in FIG. 4 and adapted for carrying the preformed octagonal sheet through a computer printer. The first portion (71) of the label (70) comprises a first rectangle (74) having a front edge (76), a left edge (78), a right edge (80), a first width (82), a first length (84), a first face (86), and a thickness (88). The first face (86) is adapted for receiving printed material from a computer printer having left and right margins. The second portion (73) comprises a second rectangle (90) having a rear edge (92), a right edge (94), a left edge (96), a second length (98) and a second width (100) that is slightly less than the first width (82). Second portion (73) includes second face (102) and third face (104) having width (100). Third face (104) is defined between a first line (106) of reduced strength and the rear edge (92). The third face is also adapted to receive printed material from the computer printer.

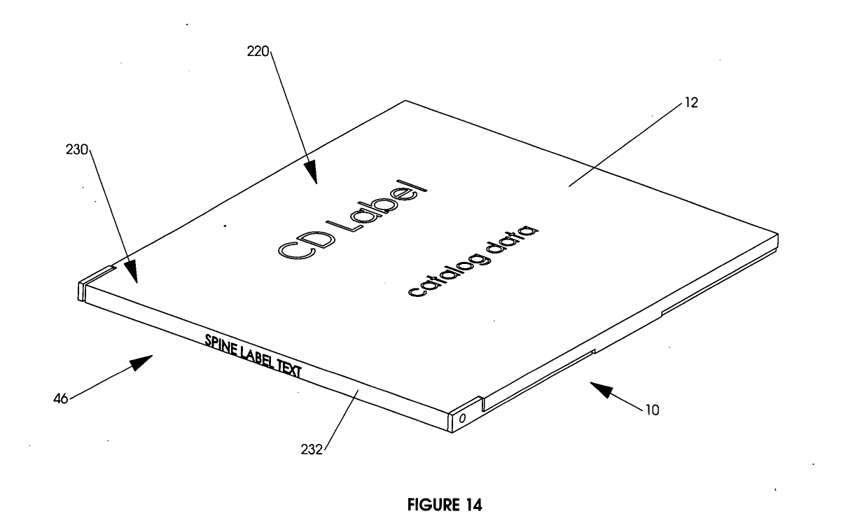

Referring now to FIG. 3A(1), the label (70) is shown as it would be removed from packaging containing the label and CD contained in a slim-line jewel case (10). The label is approximately 120 mm in width by 140 mm in total length. Second rectangle (90) left edge (96), right edge (94), second length (98) and second width (100) ensure that edges (94) and (96) do not interfere with the operations of the jewel case hinges (16) shown in FIG. 3A(3) when the case is opened and closed and so prevents dragging and creasing the label. Second width (100) is about 2 mm less than the first width (82) and the length (98) of the second portion is about 17 mm. If the first width and the second width are made equal to each other, then the overall dimensions of the label needs to be changed to about 117 mm in width by about 140 mm in total length so that the side to side movement of the label within the jewel case is minimized and there is no interference with the hinges (16). The blank label is fixed to the carrier sheet (75) and pre-determined printed material (111) is printed onto the label (70) as shown in FIG. 3A(2). The first line of reduced strength (106) is folded so that third face (104) is perpendicular to second face (102) and notches (162) and (164) form on the left and right side of the label so hinges (16) are not interfered with. Third face (104) is 4 mm in width (113). The printed and folded label is then inserted into the jewel case (10) in as shown FIG. 3A(3) so that the printed third face (104) is against the transparent spine (46) of the jewel case and printed face (86) is against the inside surface (8) of transparent cover (12). See also FIG. 14 for a view of the complete CD slim-line jewel case assembly.

The Carrier Sheet

Referring now to FIG. 4, the carrier sheet (75) is an 8.5 inch by 11 inch sheet of paper and includes a plurality of guidelines for centering the label on the carrier sheet in a proper orientation so that when the carrier sheet with the label temporarily fixed to it is passed through the printer, the label remains stationary and the first and third faces will receive printed matter in a neat and legible manner. Guideline (120) coincides with label edge (78), guideline (121) coincides with label edge (96), guideline (123) coincides with label edge (94) guide line (122) coincides with label edge (76), guideline (124) coincides with label edge (80) and guideline (126) coincides with label edge (92). Guideline (128) coincides with line of reduced strength (106). Guidelines (130) define label corner (132), guidelines (134) define label corner (136), guidelines (138) define label corner (140) and guidelines (142) define label corner (144). A subset of these guidelines may be also used to uniquely locate the desired location of label (70) on carrier page (75).

The carrier sheet also includes an adhesive area (146) adapted for temporarily fixing the label to the carrier sheet. A person skilled in the art would know that there are varieties of adhesives available that can temporarily fix the label to the carrier sheet in the manner contemplated by my invention so that the label is held and remains stable on the carrier sheet as the combination passes through a printer. The adhesive is adapted to fix and release the label without tearing the label or leaving an adhesive residue upon the label. Adhesive tape can be used as well. One advantage of using a carrier sheet in the configuration illustrated in FIG. 4 is that the combination of the label temporarily fixed to the carrier sheet and the carrier sheet can be placed in the computer printer in a portrait orientation so that the label is centered upon the carrier sheet intermediate of the printer's first and second mechanical margins, thereby permitting accurate and neat printing (111) on the first and third faces of the label as illustrated in FIG. 3A(2). My invention contemplates printing the guidelines onto the carrier sheet using software of my invention described below so that printed matter is correctly aligned on the label.

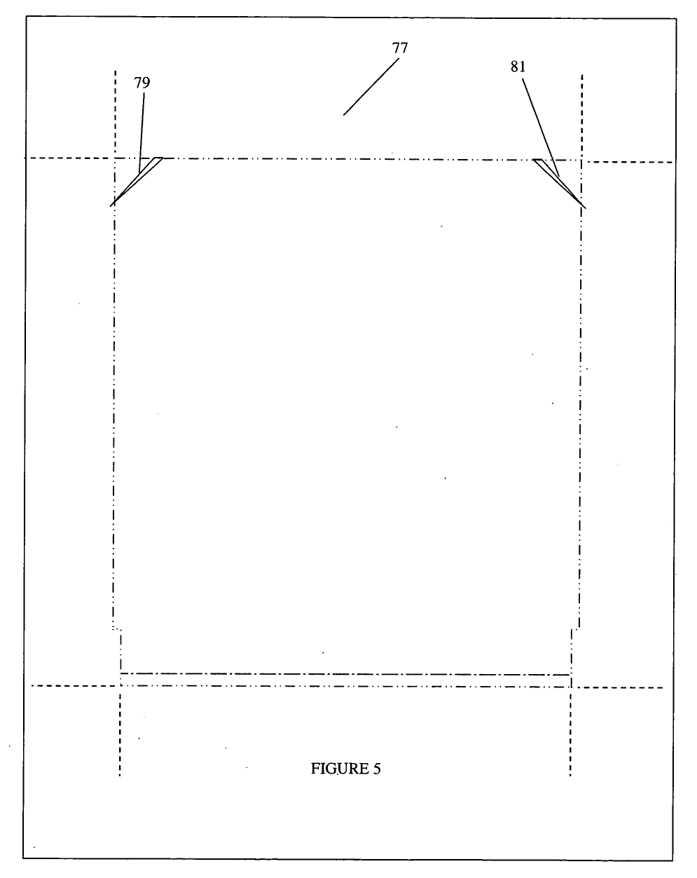

Referring to FIG. 5, there is shown another embodiment of the carrier sheet (77) wherein triangular-shaped slits (79) and (81) are cut into the carrier sheet diagonally across the corners of the carrier sheet as shown so that corresponding corners (132) and (136) of the label are fit therein and temporarily fixed to the carrier sheet in a frictional fit within the slits for transport through the computer printer. The slits may also be narrow or “zero width” slits.

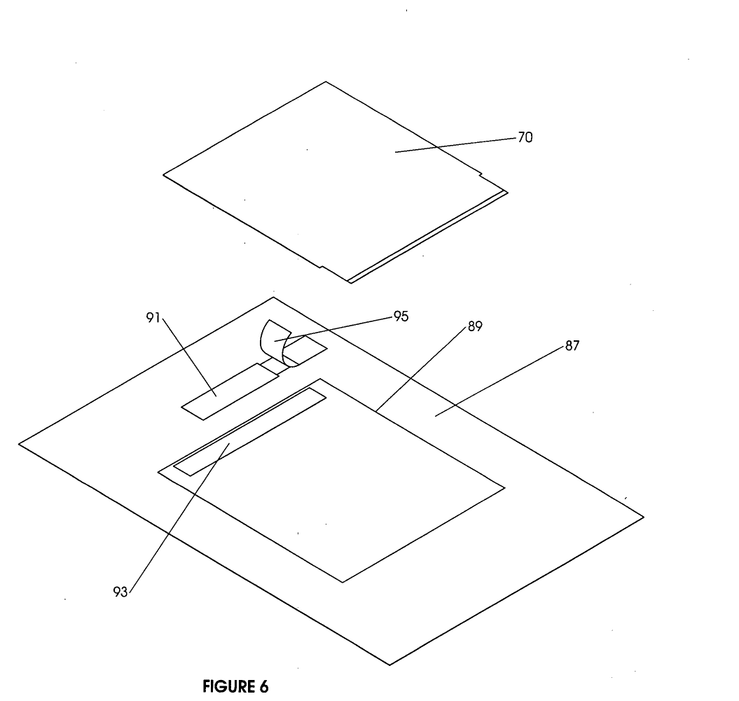

Referring to FIG. 6, there is shown another embodiment of the carrier sheet (87) wherein label (70) is placed within an area delineated by (89) which may be shaded and double-sided adhesive strip (91) about 10 cm long is placed within rectangle (93). For packaging and storage of the adhesive strip, wax paper covers (95) are used to protect the adhesive material. The side of the strip adhering permanently to the carrier sheet is covered with a high tack adhesive material and the side of the strip to temporarily fix the label to the carrier sheet is a low tack adhesive so that the label remains fixed during transport through the printer but can be removed easily after printing without damaging the label.

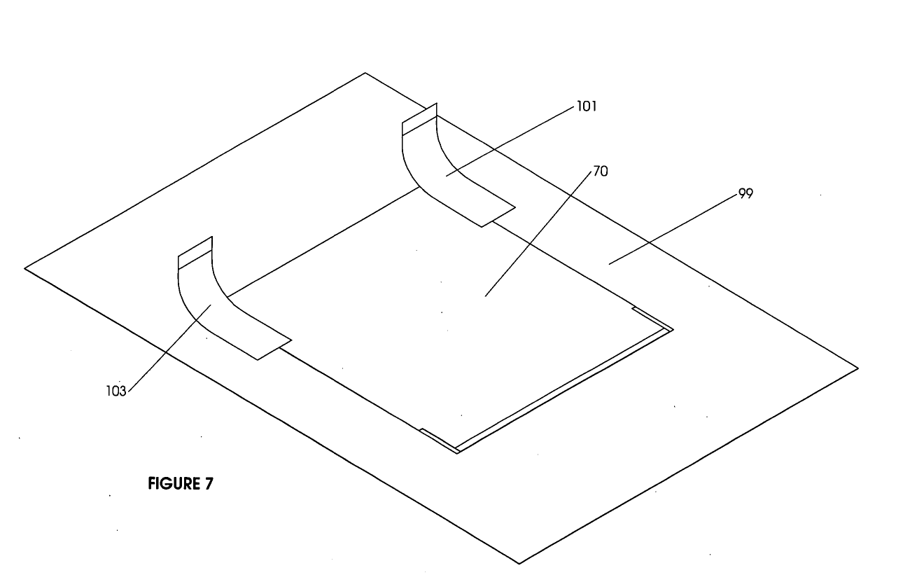

Referring to FIG. 7, there is shown yet another embodiment of the carrier sheet (99) wherein the label (70) is fixed to the carrier sheet by adhesive strips (101) and (103). The adhesive strips may be 3M Post-It Flags® which can be used to temporarily fix the label to the carrier sheet for printing and then removed.

Advantageously, the various embodiments of the carrier sheet described herein may also be used for printing photographs from computer printers having mechanical margins that do not support zero-margin printing and are not specifically adapted for printing photos. This would permit zero margin printing of photographic images right up to the edge of small sheets of photo paper fixed to the carrier sheet of my invention and using a regular colour printer. Blank photo-paper is typically of similar size to the blank CD labels described above. The software of my invention described below is able to be modified to create a carrier sheet adapted to carry blank photo paper sizes, for example, 4″×6″. Each size of photo-template can be adapted to corresponding carrier sheet guidelines that permits the user to affix a blank photo sheet at the correct location for borderless printing of the image if its 8.5″ dimension is reduced to about 8.0″ to escape the printer's margins.

Since the carrier sheet is re-used when printing each new label, it may be made of a more durable material such as plastic rather than the paper typically used for printed pages. The carrier sheet may also bear printed instructions such as how to correctly affix the label, compose the label's text and feed its leading edge into the printer.

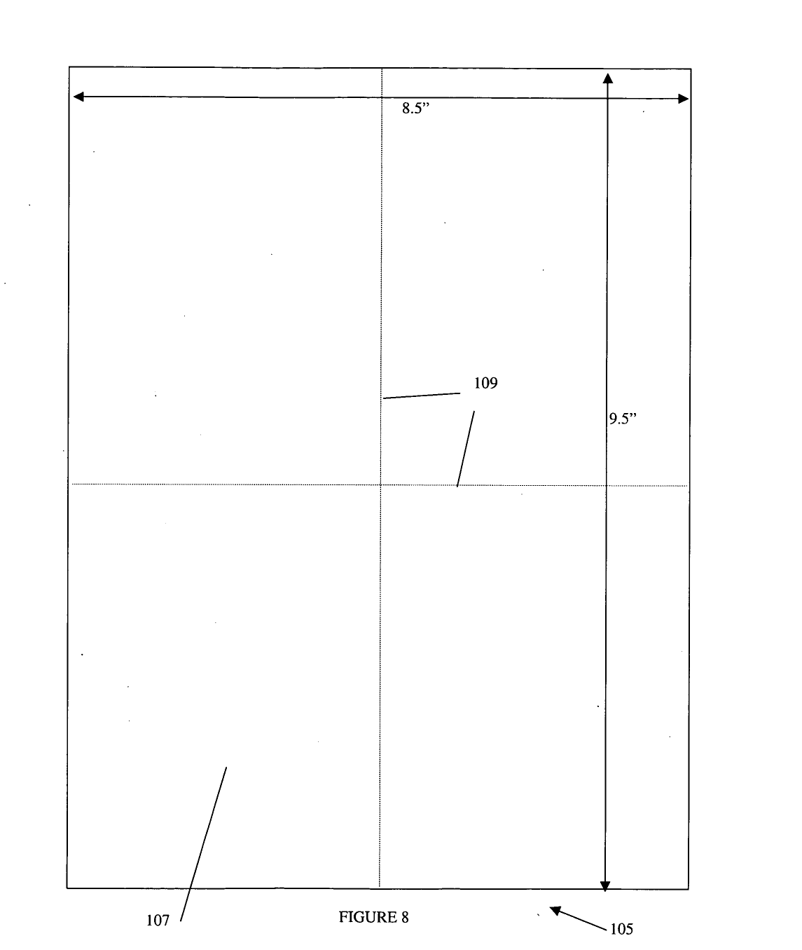

Referring to FIG. 8, my invention may include a sheet (105) of blank liner notes (107) to be included with the labels so that additional information can be printed onto the liner notes and then stored adjacent to the back of the label. The sheet is 8.5″ wide by 9.5″ high (the 8.5″ dimension can be reduced but the 9.5″ is fixed so as to span the 4.75″ of the jewel case lid). Two bisecting fold-lines (109) enable the user to accurately fold the liner-notes sheet after it's printed. The resulting 4.25″ by 4.75″ “booklet” fits perfectly inside the CD case's cover (12) where it is held in place by the four retention tabs (68) to (72) identified in FIG. 2. The software included with my invention may also include a liner note template to display and manipulate data and print lines for the liner notes.

### The Software of the Invention

My invention also includes means for composing and orienting printed matter onto the label to facilitate computer printing comprising a software component that is adapted to print material onto the label of my invention using standard word processing software in such as way that the first and third surfaces of the label receive the printed matter accurately, neatly and legibly.

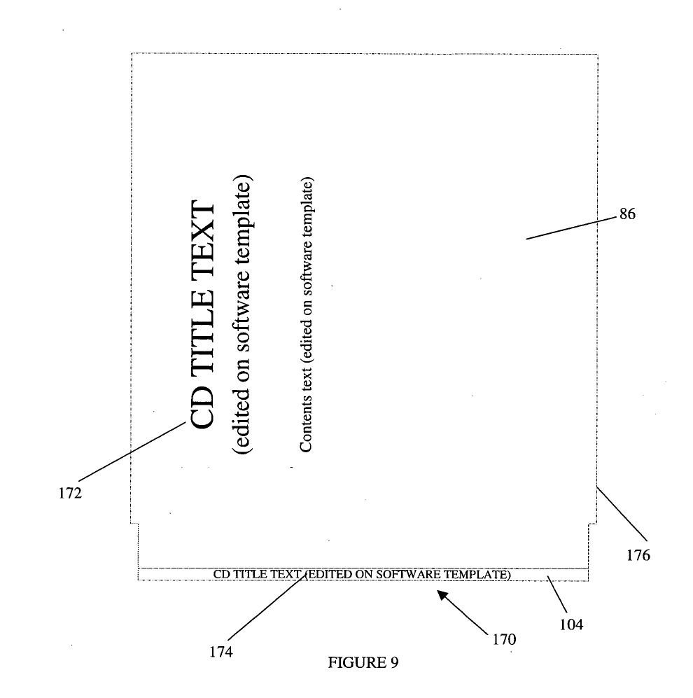

Referring to FIG. 9, there is illustrated a virtual label (170) generated using the software component of my invention that would appear on the computer screen of the user. The software is adapted to be run on a standard personal computer. The software template is coordinated to the physical dimensions of the virtual label which are equal to the dimensions of the real label described above. As well, the software coordinates the label to the guidelines of the carrier sheets also described above so that the label and the printing on the label are properly oriented with respect to the mechanical margins of the printer. A first set of printed matter (172) located in a first predetermined position on the first surface and a second set of printed matter (174) located in a second predetermined position on the third surface can be printed correctly onto the blank physical label as illustrated as item (111) in FIG. 3A(2). The dotted outline (176) shown in FIG. 9 maps the pre-determined location of the virtual blank label (170) which the user employs to compose the label's textual information. The dotted line is for on-screen visual reference purposes only and does not print; however, any textual or graphical information edited onto the template is printed when the software directs the displayed template to print on the printer. Since the template and printer are configured to share a common XY frame of reference, text sets (172) and (174) print at the same relative location on the physical label as they appear on the software template. Dotted line (176) and the guidelines shown on the carrier sheets previously discussed are coordinated to ensure proper positioning of the printed label with respect to the virtual label. My invention contemplates using such popular software as Microsoft Word® however a wide variety of word processors and graphics programs can be used to create a very basic software template requiring all data to be input via the computer's keyboard. A software label template could be freely available to all purchasers of my invention from an Internet web site. Similarly, a standard word-processing file might be used to produce the carrier pages and note-liner pages previously discussed above. Also as discussed above, the software can be easily adapted to print colour photographs on a colour printer having mechanical margins and not previously adapted for zero-margin printing. The software of my invention may be packaged with the labels on a separate CD or recorded onto every CD sold with labels. In another embodiment of my invention, the software of my invention is able to interface with the Internet and such music database sites as www.freedb.org or www.gracenote.com to obtain catalog information describing the contents of virtually all available music CDs (CD title, artist, track lengths, track titles, musical genres etc). The automatically downloaded catalog data can then be automatically formatted and inserted onto the appropriate text sets (172) and (174) on the virtual blank label thereby eliminating laborious keyboard data input. The song title data displayed on the software template can be identified from the remote Internet database using a volume identifier read directly from the disk being labeled. Alternatively, the user could type in the CD's title as the remote database query used to look up the desired labeling information. Alternatively, the labeling information could be read into the template directly from the CD's digital index without any interaction with a remote database (most relevant when cataloging MP3 music files). The same general approach used for gathering music labeling information may also be used to gather information for labeling a DVD jewel case. A centralized database such as www.DVDlister.com or www.dvdtitledb.com would be accessed through the Internet and appropriate data fields downloaded for formatted and printing (e.g. movie title, actors, plot synopsis, reviewer ratings etc). To label the jewel case containing a generic computer data CD, its file structure may be read from the disk and displayed graphically on screen to illustrate the hierarchy of folders, sub-folders and individual data files. Once the software template has been populated with the data hierarchy, its graphical representation can be printed in the set (172). To facilitate optimal data formatting, the user may be able to collapse or expand nested folders, thereby permitting the file-structure hierarchy to display only the most useful information within the limited printable area on label (170).

Descriptive title text for the data CD is typically composed by the user for display in text set (174) (e.g. “C drive backup 02/03/04” or “Family Digital Photo Files”). The data labeling routine may facilitate this top-level labeling function by automatically reading the CD's digital “volume name” and using it as the default label text. The user may then choose to override the suggested title text by editing the software template on-screen. In another embodiment of my invention, the software includes the following functions: insertion of images that serve as a background to the textual label information (i.e. background images such as photos of musicians, cover art, scenes from a movie etc); and, text scaling to take advantage of whatever label space is available (i.e. font size adjusted such that the information occupies all of the printable area). If the front surface of the label is not large enough to legibly display all of the desired catalog information, then the software partitions the data in two and format the second data-block for printing onto the back surface of the label. Suitable prompts are issued to permit the user to flip the label over and re-insert it into the printer for printing of the excess data. The software includes the ability to colour code the third face (104) to reflect music genre or data type. For example, if the disk contains music then its genre (e.g. jazz, classical, rock etc) would be used to colorize the printed spine. All or part of the spine panel's background would be coloured so that stacks of similar music CDs would line up into a contiguous color bar (e.g. green for male pop vocalist, yellow for female pop vocalist etc.). Numeric catalog codes may also be printed onto face (104) to aid in maintaining the order of large collections. The text printed on face (104) may be automatically harmonized with the text set (172) printed onto the label's first face (86). For example, the CD's title and artist shown on the main face would be automatically copied and re-formatted onto the spine with font characteristics and wording that are optimized for maximum legibility in that confined space. Calibration functions that enable the user to adjust the location at which label fields designed on the template actually print onto the paper label. For example, if after printing, text field (174) is slightly too high or low on face (104) then the user would be able to adjust that data field slightly up or down, thereby insuring that subsequent labels will print at the correct height for optimal legibility.

Referring to FIG. 10, the software template of my invention used to compose and print label text onto the label may also include functions for printing all or part of the same information onto adhesive labels for fixation to the recorded CD (183), thereby providing a complete labeling solution for both the recorded media and its storage case. For example, FIG. 10 shows two adhesive-backed “Avery ®#5160” disk labels (180) and (182). The labels display data fields (184) and (186) respectively. Such mailing labels are much less costly and more space-efficient than the large doughnut-shaped labels commonly available for labeling CDs. Thirty such mailing labels fit onto a single, letter-sized page rather than just two full-sized, circular CD labels. The same data already assembled for printing of case label is reformatted to fit onto the labels (180) and (182). The user is then prompted to insert a sheet of labels into the printer and identify the next unused label locations on the sheet. The two resulting printed mailing labels (184) and (186) are then adhered symmetrically about the disk's center, as illustrated, thereby insuring the disk's dynamic balance will be maintained during playback.

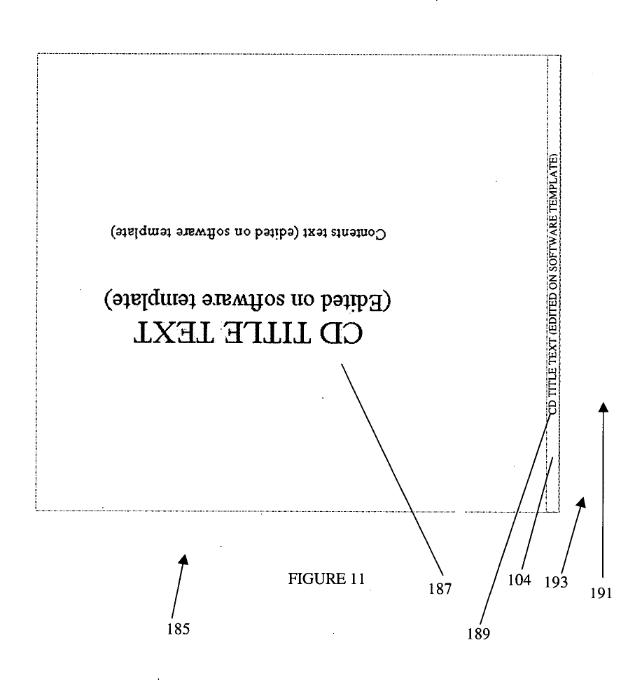

Refer now to FIG. 11. Due to mechanical constraints related to their paper handling mechanism, most desktop printers are not capable of margin-less printing. By exploiting the margin characteristics of such printers, users may still be able to print a useful amount of data onto the CD slim-line jewel case label previously illustrated. FIG. 11 illustrates a software template (185) that asymmetrically positions and orients the text sets (187) and (189) with respect to the direction of paper transport (191) such that an artificial margin (193) is created between third face (104) and the right mechanical margin of the printer thereby enabling the label's critical spine text set (189) to be relatively unaffected by any of the printer's four mechanical margins (top, bottom, left and right). Since CD jewel cases are opened from right to left (i.e. hinge and spine on the left), the main label text (187) is oriented upside-down so that when the correspondingly oriented paper label is fed through the printer (the top of the page always entering the printer first), the resulting label reads correctly when installed in its CD case.

In order to prevent skewed printing due to a small sheet of paper being unevenly grabbed as it enters the printer mechanism, a moveable fence is typically provided on printers to accommodate different paper sizes. This moveable left paper guide contacts the small sheet of paper along its left edge, thereby holding it evenly against the printer's fixed right side paper guide and maintaining orthogonal text alignment. When the label is fed into a typical printer (in correspondence with FIG. 11), its spine panel (104) is located several inches from the printer's left mechanical margin. Since most printer manufacturers do not move the left mechanical margin to correspond with the current location of the printer's moveable alignment fence, this template configuration thereby permits the critical spine label text (189) to be printed right up to the edge of the label. Thus, this “spine edge in middle” printing methodology and template partially defeats the conventional printer's inherent resistance to printing adequately onto third face (104).

The software template shown in FIG. 11 permits “spine edge in middle” labeling using many popular printers manufactured by Hewlett Packard®, Canon®, Epson® and others. Text can be printed on to face (104) however label edges (76), (78) and (80) (FIG. 3) remain subject to unprintable margins (the margin's width being variable according to the make and model of printer). If the user wishes to print background graphics over the label's entire surface or text that extends close these edges, it will be necessary to make use of the carrier sheet means and method described above.

### One Preferred Embodiment of the Pre-Formed Label

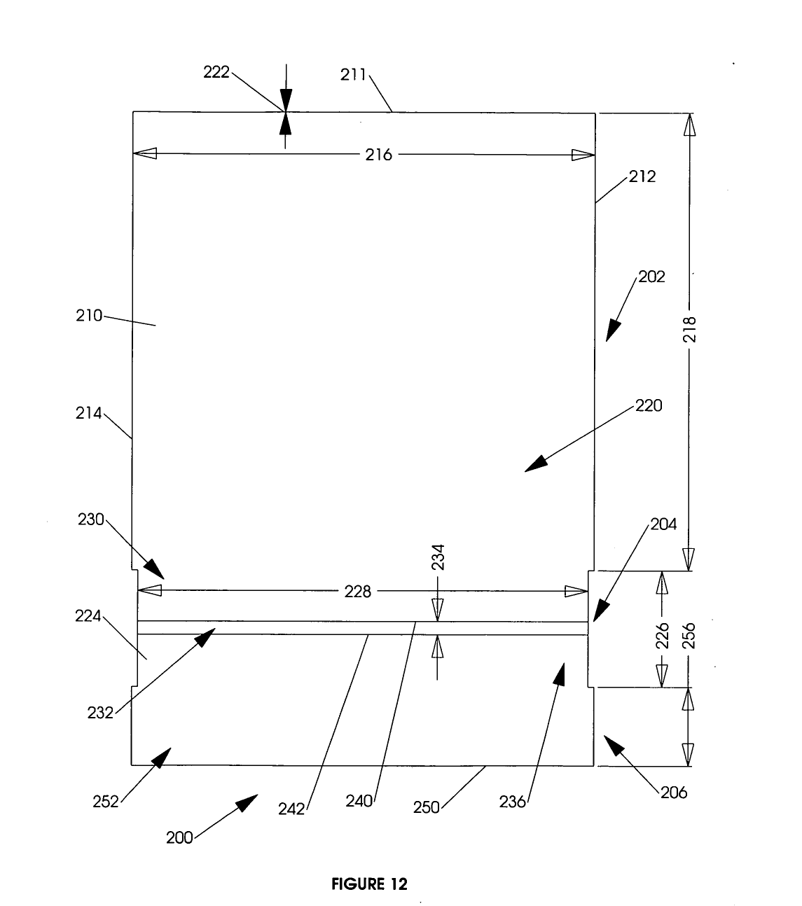

Refer now to FIG. 12. I will now describe one preferred embodiment of my invention. This preferred embodiment label (200) is a pre-formed printable blank label for a slim line CD jewel case having the characteristics described above with reference to FIG. 1 and FIG. 2. In this preferred embodiment, the pre-formed printable blank label (200) comprises a dodecagonal sheet having contiguous and adjacent first (202), second (204) and third (206) portions. The first portion comprises a first rectangle (210) having a front edge (211) left edge (214), a right edge (212), a first width (216), a first length (218), a first face (220), and a thickness (222). The first face (220) is adapted for receiving printed material from a computer printer having left and right mechanical margins and not adapted for margin-less printing. The second portion (204) comprises a second rectangle (224) having a second length (226) and a second width (228) that is slightly less than first width (216), a second face (230), a third face (232) having a third length (234) and a fourth face (236). The third face (232) is defined between a first (240) and a second (242) parallel lines of reduced strength. The third face (232) is adapted to receive printed material from the computer printer. The third portion (206) comprises a rear edge (250), a fifth face (252) having a width equal to the first width (216) and a third length (256). The main advantage of this preferred embodiment of my invention is that the label can be inserted into a computer printer for printing material independent of a carrier sheet. The label is inserted into the computer printer so that the front edge (211) is against the left margin of the computer printer so that the first (220) and second (230) faces separate the third face (232) from the printer margin. In this way the third face is intermediate the first margin said second margin of the printer permitting accurate printing upon the third face. Alternatively, the label can be inserted into the computer printer so that the rear edge (250) is against the left margin of the computer printer. In this configuration the third face (232) is separated from the left margin of the printer by the fifth face (252) and is intermediate the first margin and the second margin of the printer permitting accurate printing upon the third face. In either of these two label orientation scenarios, the software component orients the virtual label used to compose labeling information such that the information prints onto its desired label face as shown in FIG. 14. The printer's moveable paper guide is also typically positioned to constrain the label's free end, thereby maintaining orthogonallity as the label is drawn into the printer mechanism.

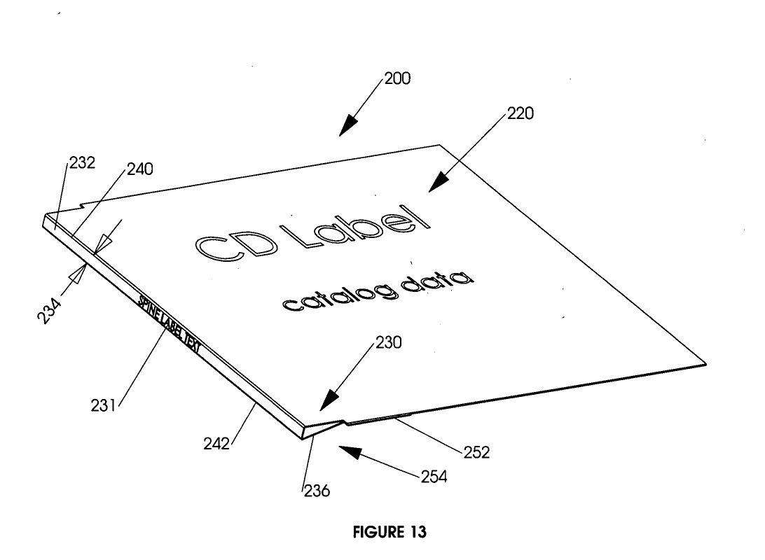

Referring now to FIG. 13, to insert this preferred embodiment label (200) into the slim line CD jewel case, the label is folded at a right angle along the first (240) parallel line of reduced strength and folded at an angle that is at least a right angle along the second (242) parallel line of reduced strength so that the label forms a triangular shaped form (254). The first (220) and second (230) faces are co-planer, adjacent and contiguous. Fourth (236) and fifth faces (252) rest below first and second faces and are separated by the distance (234) of the third face (232). The first and third faces are available to receive printed matter (231) in a neat and legible matter from a computer printer. The triangular shaped form (254) that is formed from folded faces (230), (232) and (236) result in the second and fourth faces supporting the third face against the transparent spine (46) of the jewel case (10).

Referring to FIG. 14, once the label is printed and folded the first (220) and second (230) faces are adapted for insertion into the transparent cover (12) of the jewel case (10) and the third face (232) is adapted for insertion into the transparent spine (46) of the jewel case.

Referring back to FIGS. 12, 13 and 14 the second width (228) of the second (230), third (232) and fourth (236) faces is adapted to a maintain positional agreement with the left and right hinges (16) so that they can pivot without interfering with the label. The use of third portion (206) permits the label to be rotated 180 degrees with respect to the orientation required for use with the software template described above, thereby rendering it easier to read the data prior to printing (i.e. the main text panel reads right side up and the critical spine panel does not fall within the printer's left or right mechanical margins).

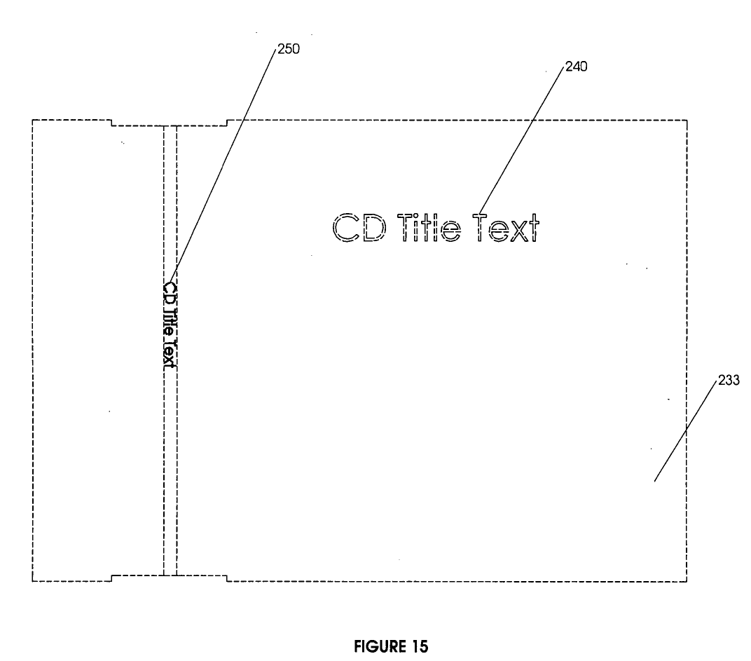

Referring to FIG. 15, there is shown a typical software template (233) that would appear on the user's computer screen required to print the second embodiment label (200) showing first set (240) and second set (250) of printed matter. This template is positioned horizontally in a landscape orientation instead of vertically or in a portrait orientation.

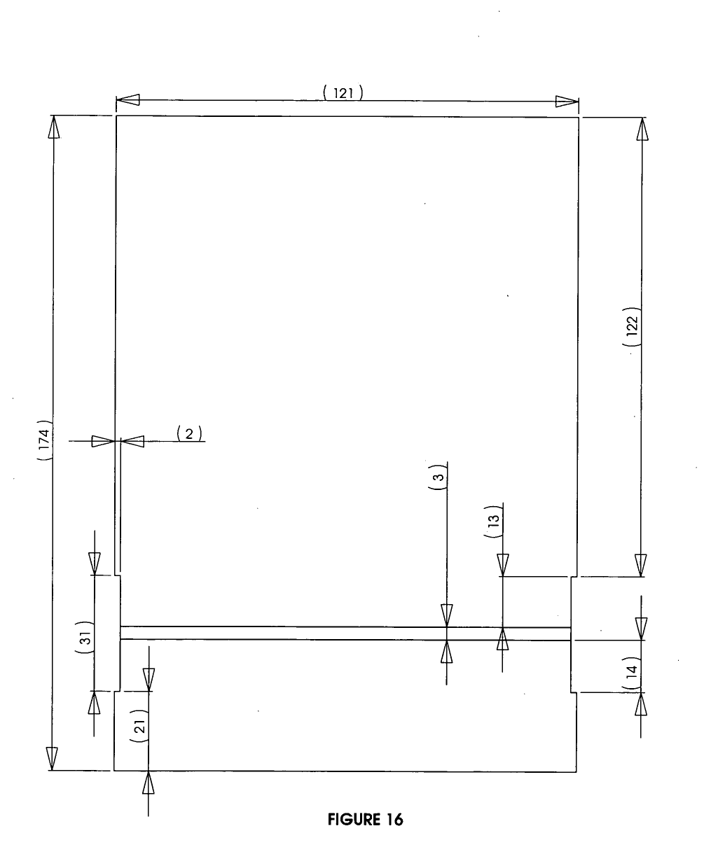

Referring to FIG. 16, there are shown appropriate dimensions in mm for one preferred embodiment label although these can vary.

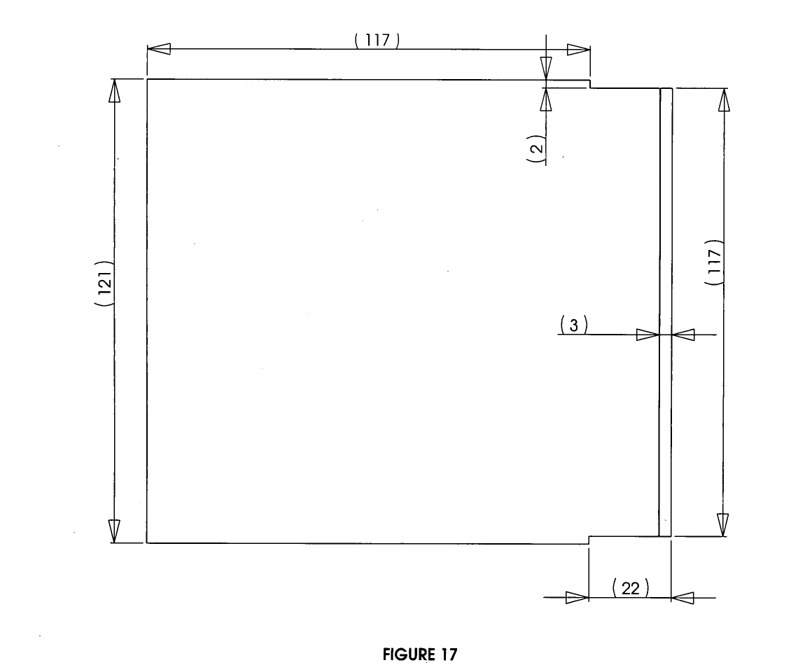

Referring to FIG. 17, there are shown appropriate dimensions in mm for one embodiment label although these can vary.

While the present invention is conceived for printing label inserts for slim line CD cases, it may also be used to print other types of labels. For example: with minor modifications, labels for standard (10 mm thick) CD cases and DVD cases can also be made using modified software, labels and carrier sheets described above. Cases for: audiocassette tapes, audio “mini-disks”, videocassette tapes etc are other applications that may utilize similar label inserts. The software template and carrier page described above may therefore include additional templates to format and print information onto common blank label inserts for such applications.

### A Third Embodiment of the Pre-Formed Label

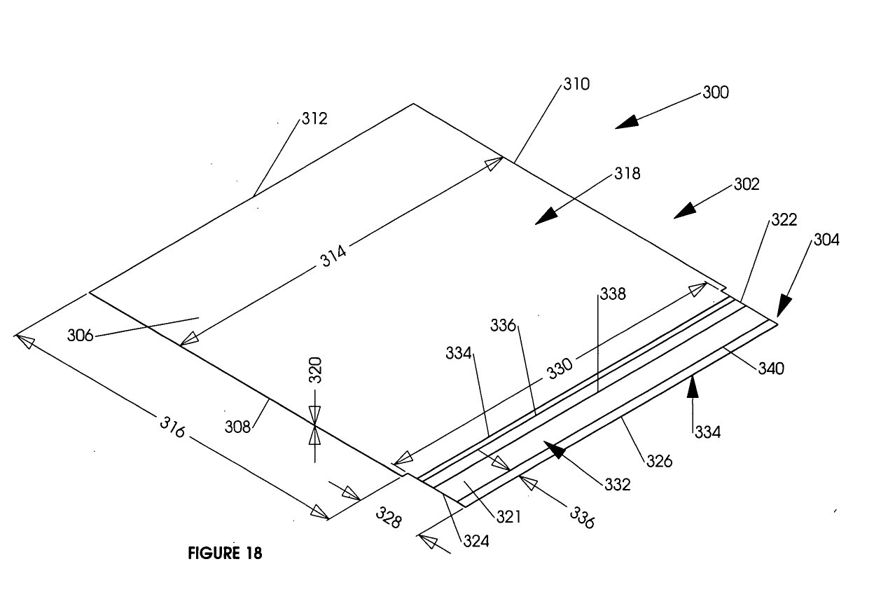

Refer back to FIG. 1, FIG. 2 and FIG. 3. When the cover (12) of the jewel case (10) is closed, ridge (65) abuts against the top surface of second face (102) of label (70) and back wall (36) top surface (6) is forced against the bottom surface of second face (102). Since ridge (65) is closer to hinge (16) than ridge back wall top surface (6) the second face of the label is bent upward against the inside of cover thereby insuring that the third face (104) remains flush inside surface of the back skirt (46) of the cover (12). However, the circumferential outer flange quarters (22) and (24) causes the first face (86) of the label to deform into a serpentine shape when the cover is closed because there are pressure points (15) and (17) located on flange quarters (22) and (24) respectively. These cause the label to bulge upwards, ridge (65) causes the label to bulge downwards and back wall top surface (6) causes the label to bulge upwards forming a sinusoidal deformation in the label. Points (15) and (17) may also cause unsightly dimples to form in the visible surface of the label. The tension in the label caused by the sinusoidal deformation creates a slight outward pressure within the CD causing it to bulge slightly open near hinges (16). Hence the rear portion of the slim line jewel case may be slightly thicker than the front portion of the case. When the cases are stacked, this deformity creates a tilting effect making vertical storage difficult and unattractive. To reduce these effects, there is a third embodiment of my pre-formed label illustrated in FIG. 18. The third embodiment of the label (300) comprises a first portion (302) and a second portion (304). The first portion comprises a first rectangle (306) having a left edge (308), a right edge (310), a front edge (312), a first width (314), a first length (316), a first face (318), and a thickness (320). First face (318) is adapted for receiving printed material from a computer printer having left and right margins. Second portion (304) comprises a second rectangle (321) having a right edge (322), a left edge (324), a rear edge (326), a second length (328), a second width (330) that is slightly less than the first width (314), a second face (332) and a third face (334) having a third width (336). Second face (332) comprises at least three adjacent and parallel lines (334), (336), and (338) of reduced strength having an inherent tendency to absorb compression, so that when the CD jewel case is closed the label remains essentially flat within the case. The first line (334) in this embodiment is coincident with points (15) and (17). The second line (336) is coincident with the back wall top surface (6) and the third line (338) is coincident with back ridge (65). If necessary other lines of reduced strength can be inscribed on the surface of the label as required. Third face (334) is defined between a fourth line (340) of reduced strength and the rear edge (326) and is adapted to receive printed material from the computer printer. This illustrated embodiment of the invention also relies upon the carrier sheets previously discussed and described. These supplementary lines of reduced strength may also be formed in the embodiment of the label shown in FIG. 12.

The thickness (320) of the paper used for the label will also influence the amount of tension created by the label in the closed jewel case. The thinner the paper, the easier it will conform to the serpentine path needed to fit inside the closed CD case. If the paper is too thin then dimpling will be apparent from points (15) and (17) and a flimsy appearance will result. Experience shows that semi-gloss paper approximately 0.15 mm thick provides a good compromise: flexible enough to minimize the tilting effect while still providing a high quality print surface with enough stiffness to facilitate removal from the carrier page. Notwithstanding this experience, a wide variety of papers of different thickness and composition are adaptable to the present invention.

Modified Slim-Line Jewel Case

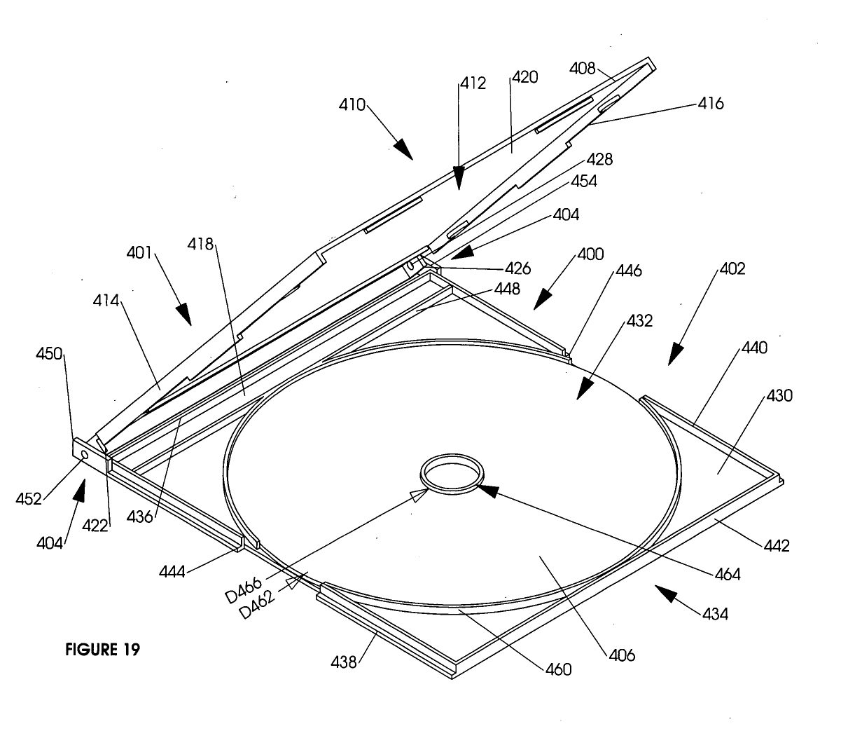

Referring to FIG. 19, simple modifications to the design of the slim line jewel case can result in a flat disposition of the label within the closed jewel case and prevent dimpling and folding of the label. The embodiment of the slim-line CD jewel case can be used for any embodiment of the labels of my invention. The modified CD slim line jewel case (400) for holding a CD having an outer diameter and an centered aperture having an inner diameter comprises a cover (401), a base (402) pivotally fixed to the cover by hinges (404), and a CD tray (406) for holding the CD tightly. The cover (401) comprises a first rectangular body (408) having a top surface (410), a bottom surface (412), a left skirt (414), a right skirt (416), a rear skirt (418), a front open end (420), a rearward left projection (422) having a first aperture (424) and a rearward right projection (426) having a second aperture (428).

The base (402) comprises a second rectangular body (430) having a top surface (432), a bottom surface (434), a rear wall (436), a left side wall (438), a right side wall (440), a front wall (442). The left side wall (438) includes a left side flange (444) and the right side wall (440) includes a right side flange (446). The base further comprises an interior wall (448) adjacent to and parallel to the rear wall (436) and spaced a predetermined distance from the rear wall. The left side wall (438) includes a rearward left projection (450) having a first pin (452) and the right side wall (440) includes a rearward right projection (454) having a second pin (456). The CD tray (406) comprises a first outer circular wall (460) having an inside diameter (D462) equal to the outside diameter of a CD and a second inner wall (464) having an outside diameter (D466) equal to the inside diameter of the CD aperture diameter. The second inner wall is adapted to engage the CD aperture so that the CD is removably fixed within the tray. In this embodiment of the jewel case, the CD tray first outer circular wall (460) is circumscribed within the rectangle formed by the base front wall (442), left side wall (438), right side wall (440) and interior wall (448). The hinge means comprises the rearward left projection (450) having the first inwardly protruding pin (452), the rearward right projection (454) having the second inwardly protruding pin (456), the rearward left projection having a first aperture (424) and the rearward right projection having a second aperture (428) such the first pin meshes with the first aperture and the second pin meshes with the second aperture so that the cover and base are joined in a pivoting relationship at their respective rearward ends.

The interior wall (448) is tangent to the outer wall of the CD tray (460) and therefore the sharp points (15) and (17) in the embodiment shown in FIG. 1 are eliminated. The combination of interior wall (448) cooperating with rear wall (436) means that the dimpling of the label is avoided and the serpentine bending of the label is less pronounced. This in turn reduces the tendency of the jewel case to partially open and cause a tilting effect when stacked.

Packaging the Labels Together with the Slim-Line CD Jewel Case

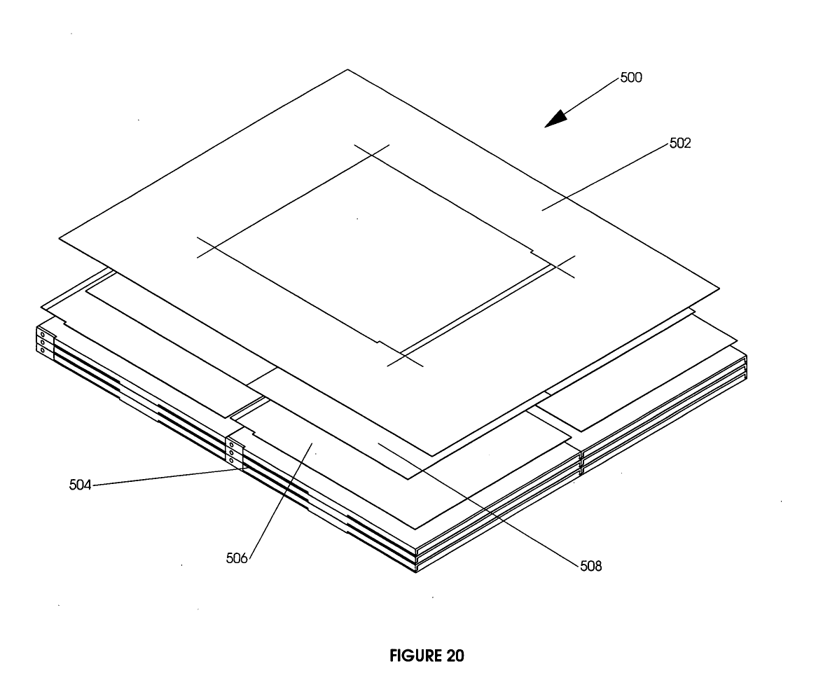

Referring to FIG. 20, one embodiment of my invention contemplates being able to package a plurality of CD slim-line jewel cases. Compact packaging for efficient transport and retail display is one of the present invention's principal benefits and can take one of several forms depending on the end-user's requirements. For example, if the user requires blank recording media and jewel cases as well as a case labeling capability that includes edge-to-edge graphics, then all of the components illustrated in FIG. 20 may be supplied. FIG. 20 illustrates a partially exploded view of a shrink-wrapped assembly (500) comprised of carrier-page (502), a plurality of slim line CD jewel cases (504) a plurality of label inserts (506) and a plurality of liner-notes (508). The assembly (500) is tightly shrink-wrapped (not shown) and so the plurality of slim line CD jewel cases (504) form a rigid structure of sufficient dimensions to protect flexible carrier page (502) from being damaged during transport and retailing. Adhesive labels (not illustrated) may also be included as a layer in the sandwiched assembly. Each of the plurality of labels (506) is stored flat against the outside of plurality of jewel cases (504). Alternatively, each of the plurality of jewel cases may contain at least one of the plurality of labels already inserted as previously described. If the label is delivered inside its case, the user wishing to print label data onto it must first extract the blank label and flatten it prior to printing with software templates contemplated and described herein. Usually, a printer roller-feed mechanism will insure complete flattening of the label as its slightly folded third surface (104) passes under the print heads. This mode of label packaging is best suited to a manufacturer of blank CD media since they are able to insert a blank label at the factory prior to each CD case being individually shrink-wrapped. If such is the case, the label may be printed with retail sales graphics on one side and be blank on the other. The end-user would then remove the label and print catalog data onto its blank reverse side, thereby permitting the same piece of paper to serve both as an advertising medium for blank media and an after-sales label for its recorded contents.

The package (500) may also include a separate CD containing the software templates contemplated and described herein. Alternatively, as previously noted, the appropriate software template corresponding to the user's particular printer and graphical requirements may be downloaded from a website.

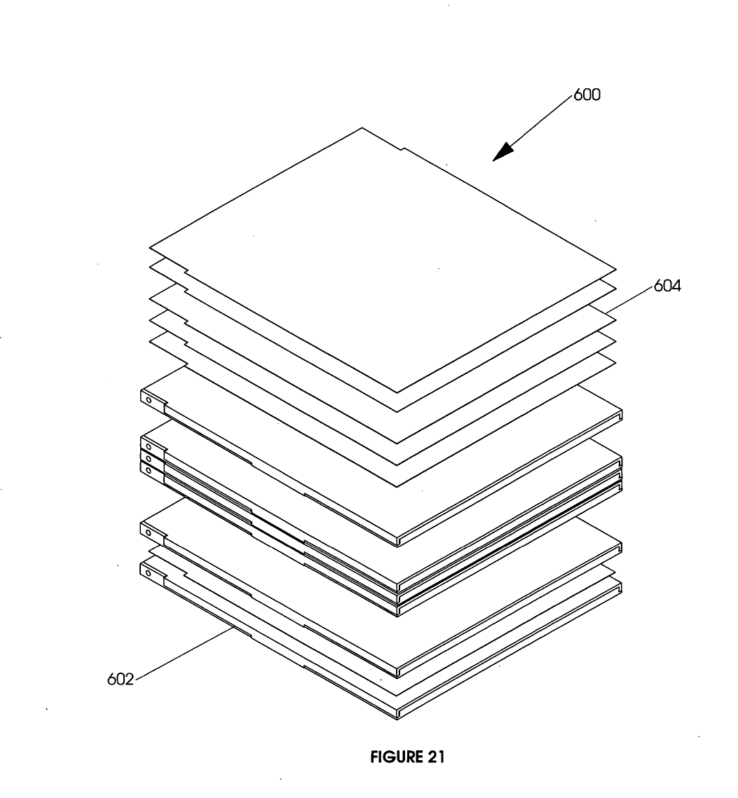

FIG. 21, illustrates a more compact and preferred packaging configuration (600) using a preferred embodiment of my invention. No carrier page is included. Since no carrier sheet is required, all of the plurality of jewel cases (602) can be single-stacked together with a corresponding plurality of preferred embodiment labels (604).

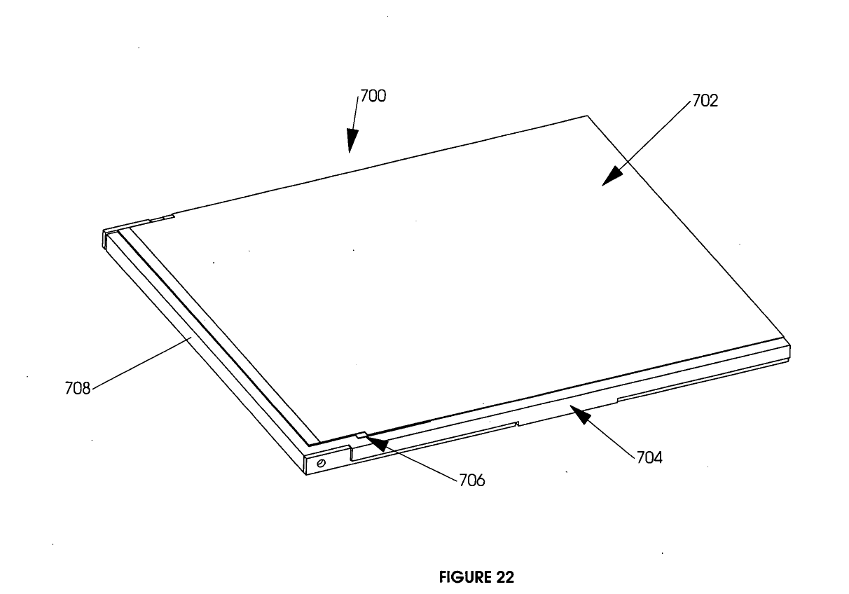

FIG. 22 is a close up of a set (700) comprising a single CD case (704) and preferred embodiment label (702) suitable for stacked packaging such as shown in FIG. 21. The preferred embodiment label (702) is folded so that at (706) the fourth and fifth faces are folded below the first, second and third faces of label (702). The third face is adapted for insertion into the spine (708) of the case.

A method of packaging a slim-line CD jewel cases as shown in FIG. 21 and FIG. 22 comprising the steps of:
a. taking an empty slim-line CD jewel case;
b. folding a dodecagonal sheet along said second line of reduced strength so that the fourth and fifth faces are co-planer and located below the first, second and third faces;
c. placing said dodecagonal sheet on top of said empty slim-line CD jewel case;
d. repeating steps a to c for a plurality of empty slim-line CD jewel case;
e. stacking said plurality of slim-line CD jewel cases; and,
f. shrink-wrapping said plurality of slim-line CD jewel cases.

If the user already possesses a library of recorded CDs in standard jewel cases and only wishes to re-package them into labeled slim line cases in accordance with the present invention, then the blank CDs may be omitted from the above-described package. Only slim line cases and blank labels such as the one shown in FIG. 3 are included in the package together with the software template needed to exploit them. The software may be included with the package or downloadable from a website. If carrier page printing capability is desired then adhesive strips are included with the blank labels.

The included slim line CD jewel cases included in all of the described packaging configures may be of the type described in FIGS. 3 and 18 or the type described in FIG. 12.

This description contains much specificity that should not be construed as limiting the scope of the invention but merely provides illustrations of some of its embodiments. Thus the scope of the invention should be determined by the appended claims and their legal equivalents rather than by the examples given.

What is claimed is:

1. A pre-formed printable blank label system for a slim-line CD jewel case, wherein said slim-line CD jewel case comprises a transparent cover, a transparent spine integral with said transparent cover, a tray for holding a CD, a first hinge and a second hinge, and wherein said pre-formed printable blank label system comprises;
a. a label comprising a preformed octagonal sheet having planar, contiguous and adjacent first and second portions adapted to receive a first set of printed matter from a computer printer in a first predetermined position and a second set of printed matter from said computer printer in a second predetermined position, wherein the computer printer has first and second mechanical margins;
b. a carrier sheet adapted for carrying said label through the computer printer; and,
c. means for composing said first and second sets of printed matter so that the first and second set of printed matter is transferred to said first and second predetermined positions respectively on the label.

2. The system as claimed in claim 1, wherein said first portion comprises a first rectangle having a front edge, a left edge, a right edge, a first width, a first length, a first face, and a thickness, and wherein said first face includes the first predetermined position for receiving the first set of printed matter.

3. The system as claimed in claim 2, wherein said second portion comprises a second rectangle having a rear edge, a left edge, a right edge, a second length and a second width that is slightly less than said first width, a second face and a third face having said second width, wherein said third face is defined between a first line of reduced strength and said rear edge, and further wherein the third face includes the second predetermined position adapted to receive the second set of printed matter.

4. The system as claimed in claim 3, wherein said carrier sheet includes a plurality of guidelines for centering the label thereupon in proper orientation so that the first and second sets of printed matter are accurately received within the first and second predetermined positions respectively during printing, and wherein the label is temporarily fixed adhesively to the carrier sheet so that when the combination carrier sheet and label are passed through the computer printer, the label remains stationary and stable on the carrier sheet.

5. The system as claimed in claim 4, wherein the combination of the label and the carrier sheet are placed in the computer printer in a portrait orientation, and wherein the label is centered upon the carrier sheet in portrait orientation intermediate of said first and second printer margins.

6. The system as claimed in claim 1, wherein the second portion comprises a second rectangle having a rear edge, a left edge, a right edge, a second length and a second width that is slightly less than said first width, a second face and a third face having said second width, wherein said second face includes at least a first, second and third parallel and spaced lines of reduced strength, wherein said at least first, second and third parallel lines of reduced strength are adapted to yield to contact pressures caused by closure of the CD slim-line jewel case so the label does not deform within the CD slim-line jewel case.

7. The system as claimed in claim 1, wherein said means for composing the first and second sets of printed matter so that the first set of printed matter is placed within the first predetermined position and the second set of printed matter is placed within the second predetermined positions comprises a digitized template adapted for display on a screen of a computer, wherein said digitized template comprises a virtual display of the label, and further wherein said virtual display includes a first data field for composing the first set of printed matter in a virtual first predetermined position and a second data field for composing the second set of printed matter in a virtual second predetermined position.

8. The system as claimed in claim 7, wherein said computer is adapted to print the virtual display onto the label as it passes through the computer printer.

9. The system as claimed in claim 8, wherein the means for composing is adapted to connect to the Internet so that information contained therein may be transferred to the digitized template.

10. A pre-formed printable blank label system for a slim-line CD jewel case, wherein said slim-line CD jewel case comprises a transparent cover, a transparent spine integral with said transparent cover, a tray for holding a CD, a first hinge and a second hinge, and wherein said pre-formed printable blank label system comprises;
a. a preformed dodecagonal sheet having planar, contiguous and adjacent first, second and third portions adapted to receive a first set of printed matter from a computer printer in a first predetermined position and a second set of printed matter from said computer in a second predetermined position, wherein said computer printer has first and second mechanical margins; and,
b. means for composing said first and second set of printed matter so that the first and second set of printed matter is transferred to said first and second predetermined positions respectively on the label.

11. The system as claimed in claim 10, wherein the first portion comprises a first rectangle having a front edge, a left edge, a right edge, a first width, a first length, a first face, and a thickness, and wherein said first face includes the first predetermined position for receiving the first set of printed matter from the computer printer.

12. The system as claimed in claim 11, wherein the second portion comprises a second rectangle having a second length and a second width that is slightly less than said first width, a second face and a co-planar third face having a third width and a co-planar fourth face, wherein said third face is defined between a first and a second parallel lines of reduced strength and includes the second predetermined position adapted to receive the second set of printed matter.

13. The system as claimed in claim 12, wherein said third portion comprises a fifth face having a third width equal to the first width and a third length.

14. The system as claimed in claim 13, wherein the label is inserted in a landscape orientation into the computer printer independent of a carrier sheet.

15. The system as claimed in claim 14, wherein the label is folded at a right angle along said first parallel line of reduced strength, and wherein the label is further folded at an angle that is at least a right angle along said second parallel line of reduced strength thereby creating a triangular folded portion adapted to ensure that the third face remains within the transparent spine of the CD jewel case.

16. The system as claimed in claim 15, wherein the second width is adapted to maintain positional agreement with said first and second CD slim line jewel case hinges thereby allowing the first and second hinges to pivot without interfering with the label.

17. A pre-formed printable blank label system for a slim line CD jewel case, wherein said slim line CD jewel case comprises a transparent cover, a transparent spine integral with said transparent cover, a tray for holding a CD, a first hinge and a second hinge, and wherein said system comprises a label comprising a pre-formed octagonal sheet having planar, contiguous and adjacent first and second portions, a plurality of adjacent and parallel lines of reduced strength within said second portion, and a carrier sheet adapted for carrying the label through a computer printer.

18. The system as claimed in claim 17, wherein said plurality of adjacent and parallel lines of reduced strength comprise a first, second and third line of reduced strength, and further wherein said first second and third lines of reduced strength are adapted to prevent deformation of the label within the CD slim line jewel case by absorbing compressive forces exerted on the label when the jewel case is closed.

19. A CD slim line jewel case for holding a CD having an outer diameter and a centered aperture having an inner diameter, wherein said CD slimline jewel case comprises a cover, a base pivotally fixed to said cover by hinging means, and a CD tray for holding said CD tightly therein, wherein:
a. the cover comprises a first rectangular body having a top surface, a bottom surface, a left skirt, a right skirt, a rear skirt, a front open end, a rearward left projection having a first inwardly protruding pin and a rearward right projection having a second inwardly protruding pin;
b. said base comprises a second rectangular body having a top surface, a bottom surface, a rear wall, a left side wall, a right side wall, a front wall, wherein said left side wall includes a left side flange and said right side wall includes a right side flange, and wherein the base further comprises an interior wall adjacent to and parallel to said rear wall and spaced a predetermined distance there from, and wherein said left side wall includes a rearward left apertured projection and said right side wall includes a rearward right apertured projection;
c. the CD tray comprises a first outer circular wall having an inside diameter equal to said outside diameter of a CD, a second inner wall having an outside diameter equal to the inside diameter of said CD aperture diameter, wherein said second inner wall is adapted to engage the CD aperture so that the CD is removeably fixed within the tray, and wherein said CD tray first outer circular wall is circumscribed within the rectangle formed by the base front wall, left side wall, right side wall and intermediate wall; and,
d. said hinge means comprises the rearward left projection having the first inwardly protruding pin, the rearward right projection having the second inwardly protruding pin, the rearward left projection having a first aperture and the rearward right projection having a second aperture such the first pin meshes with the first aperture and the second pin meshes with the second aperture so that the cover and base are joined in a pivoting relationship at their respective rearward ends.

20. A method of packaging a slim-line CD jewel cases comprising the steps of:
a. obtaining an empty slim-line CD jewel case;
b. folding a dodecagonal sheet along said second line of reduced strength so that the fourth and fifth faces are co-planer and located below the first, second and third faces;
c. placing said dodecagonal sheet on top of said empty slim-line CD jewel case;
d. repeating steps a to c for a plurality of empty slim-line CD jewel case;
e. stacking said plurality of slim-line CD jewel cases; and,
f. shrink-wrapping said plurality of slim-line CD jewel cases.
